(19) United States
(12) Patent Application Publication
(10) Pub. No.: US 2025/0264326 A1
(43) Pub. Date: Aug. 21, 2025

(54) THREE-DIMENSIONAL SHAPE MEASUREMENT DEVICE AND THREE-DIMENSIONAL SHAPE MEASUREMENT METHOD

(71) Applicant: JVCKENWOOD CORPORATION, Yokohama-shi (JP)

(72) Inventor: Osamu GOCHO, Yokohama-shi (JP)

(21) Appl. No.: 19/201,367

(22) Filed: May 7, 2025

Related U.S. Application Data
(63) Continuation of application No. PCT/JP2023/039012, filed on Oct. 30, 2023.

(30) Foreign Application Priority Data
Nov. 11, 2022 (JP) 2022-181270

(51) Int. Cl. G01B 11/24; G01S 7/4865; G01S 17/10

(52) U.S. Cl. CPC G01B 11/24; G01S 7/4865; G01S 17/10

(57) ABSTRACT

A three-dimensional shape measurement device: obtains, as a reference exposure output amount, an exposure output amount for each pixel detected at an exposure timing where all of reflected light reflected by a measurement object for a single light emission from a light emitter is received, computes a measurement condition for each pixel based on the reference exposure output amount obtained for each pixel; measures a distance to the measurement object for each pixel under the measurement condition based on the exposure output amount for each pixel detected at an exposure timing where the exposure output amount increases as a light reception timing where the reflected light for the single light emission from the light emitter is received by an imaging element is delayed to a light emission timing of the light emitter; and generates three-dimensional shape information of the measurement object using information on the distance for each pixel.

### CROSS-REFERENCE TO RELATED APPLICATIONS

The present application is a continuation of International Application No. PCT/JP2023/039012, filed on Oct. 30, 2023, and based upon and claims the benefit of priority from Japanese Patent Application No. 2022-181270, filed on Nov. 11, 2022), the entire contents of which are incorporated herein by reference.

### TECHNICAL FIELD

The present disclosure relates to a three-dimensional shape measurement device and three-dimensional shape measurement method.

### BACKGROUND

Normally, the amount of light exposed on an imaging element when photographing is performed with a digital camera device is determined by six parameters: (i) light source emission intensity, (ii) subject reflectance, (iii) lens T value, (iv) lens aperture, (v) sensor exposure time, and (vi) signal amplification amount by a circuit.

When photographing, a photographer changes parameters (iv), (v), and (vi) according to parameters (i), (ii), and (iii) described above, and in some cases, increases or decreases the parameter (i) to set an appropriate imaging condition. For example, the photographer sets a photographing condition by adjusting these parameters according to a signal intensity balance between a main subject and a secondary subject.

Meanwhile, a three-dimensional shape measurement device using a dToF (direct Time of Flight) system obtains an exposure output amount necessary for measuring the distance to a measurement object by changing the phase of a laser pulse emitted and exposed to an image sensor (imaging element). At that time, since laser emission time is very short, it is difficult to obtain a sufficient exposure output amount in a single light emission and exposure. Thus, the necessary exposure output amount can be obtained by repeating the light emission and exposure multiple times, at an interval longer than sensor exposure time.

### SUMMARY

In order for a three-dimensional shape measurement device using the dToF system to accurately perform distance measurement for a measurement object, it is required to obtain an appropriate exposure output amount in all pixels of an image sensor. However, it may not be possible to obtain an appropriate exposure output amount in all pixels of the image sensor, depending on measurement conditions, such as when a measurement object is made of a material having a low reflectance of laser light, when the distance from the three-dimensional shape measurement device to a measurement object is long, or when there is part where reflected light from a measurement object cannot be obtained due to the position of laser emission.

In addition, analog signal amplification control and exposure control of the image sensor are performed as one unit per screen, and the exposure output amount cannot be adjusted for each pixel.

It is desirable to provide a three-dimensional shape measurement device and a three-dimensional shape measurement method capable of measuring a three-dimensional shape by obtaining data on distance measurement for a measurement object in multiple pixels in an image sensor with uniform accuracy.

A three-dimensional shape measurement device in accordance with some embodiments includes: a light emitter configured to emit laser light toward a measurement object; an imaging element having pixels and configured to: receive reflected light that is the laser light reflected by the measurement object based on a prescribed exposure condition for each pixel; perform photoelectric conversion; and output the photoelectric conversion as an output signal; an output amount detector configured to detect an amount of exposure output for each pixel for a single light emission from the light emitter based on the output signal; a computational unit configured to: obtain, as a reference exposure output amount, an exposure output amount for each pixel detected by the output amount detector at an exposure timing where all of the reflected light for the single light emission from the light emitter is received; and compute a measurement condition for each pixel based on the reference exposure output amount obtained for each pixel; a measuring unit configured to measure a distance to the measurement object for each pixel under the measurement condition based on the exposure output amount for each pixel detected by the output amount detector at an exposure timing where the exposure output amount increases as a light reception timing where the reflected light for the single light emission from the light emitter is received by the imaging element is delayed to a light emission timing where the light emitter emits; and a shape information generator configured to generate three-dimensional shape information of the measurement object using information on the distance to the measurement object for each pixel.

A three-dimensional shape measurement method in accordance with some embodiments is performed by a three-dimensional shape measurement device including: a light emitter configured to emit laser light toward a measurement object; an imaging element having pixels and configured to: receive reflected light that is the laser light reflected by the measurement object based on a prescribed exposure condition for each pixel; perform photoelectric conversion; and output the photoelectric conversion as an output signal; and an output amount detector configured to detect an amount of exposure output for each pixel for a single light emission from the light emitter based on the output signal. The method includes: obtaining, as a reference exposure output amount, an exposure output amount for each pixel detected by the output amount detector at an exposure timing where all of the reflected light for the single light emission from the light emitter is received, calculating a number of accumulations to bring the reference exposure output amount for each pixel closer to a prescribed target value of the exposure output amount, and calculating, based on the calculated number of accumulations, a number of light emissions and exposures for each pixel which is the measurement condition for each pixel for measuring a distance to the measurement object; measuring, under the calculated number of light emissions and exposures, the distance to the measurement object for each pixel under the measurement condition based on the exposure output amount for each pixel detected by the output amount detector at an exposure timing where the exposure output amount increases as a light reception timing where the reflected light for the single light emission from the light emitter is received by the imaging element is delayed to a light emission timing where the light emitter emits; and generating three-dimensional shape information of the measurement object using information on the measured distance to the measurement object for each pixel.

### BRIEF DESCRIPTION OF DRAWINGS

FIG. 1 is a block diagram illustrating a configuration of a 3D shape measurement device according to one or more embodiments.

FIG. 2A is a diagram illustrating the amount of exposure output which is output from a pixel when the 3D shape measurement device emits laser light with a measurement object included in a subject, and performs exposure to include all of the laser light reflected by the measurement object.

FIG. 2B is a diagram illustrating the amount of exposure output which is output from a pixel when exposure is performed at a timing where the amount of exposure output increases as laser light reflected by a measurement object is delayed relative to light emission timing.

FIG. 2C is a diagram illustrating the amount of exposure output which is output from a pixel when exposure is performed without emitting light with a measurement object part not included in a subject.

FIG. 3 is a flowchart illustrating processing when the 3D shape measurement device according to one or more embodiments performs a computational process of a measurement condition.

FIG. 4 is a flowchart illustrating a measurement process performed by the 3D shape measurement device according to one or more embodiments.

### DETAILED DESCRIPTION

A configuration of a three-dimensional (3D) shape measurement device and a 3D shape measurement method according to an embodiment of the present invention will be described below with reference to the drawings.

### <Configuration of 3D Shape Measurement Device>

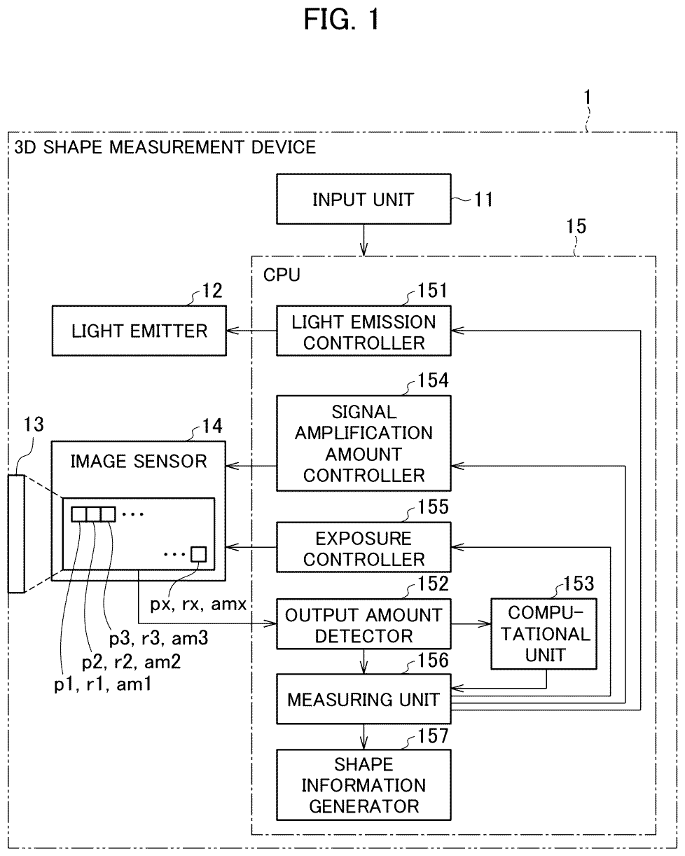

FIG. 1 is a block diagram illustrating a configuration of a 3D shape measurement device 1 according to one or more embodiments. The 3D shape measurement device 1 measures the shape of a measurement object, and includes an input unit 11, a light emitter 12, a lens 13, an image sensor (imaging element) 14, and a central processing unit (CPU) 15.

The input unit 11 inputs information regarding operation by a user. The light emitter 12 emits laser light toward a measurement object. The lens 13 receives reflected light which is laser light emitted from the light emitter 12 and reflected by the measurement object. The image sensor 14 includes x pixels p1 to px, light receivers r1 to rx, and signal amplifiers am1 to amx. The light receivers r1 to rx are provided for pixels p1 to px, respectively. The signal amplifiers am1 to amx are provided for pixels p1 to px, respectively.

Hereinafter, when it is not specified which of the pixels p1 to px is used, “pixel p” is mentioned. Similarly, when it is not specified which of the light receivers r1 to rx is used, “light receiver r” is mentioned. Similarly, when it is not specified which of the signal amplifiers am1 to amx is used, “signal amplifier am” is mentioned.

The light receiver r receives light coming from the lens 13, based on a prescribed exposure condition, and performs photoelectric conversion. The signal amplifier am stores a charge generated by photoelectric conversion in the corresponding light receiver r. The signal amplifier am converts and amplifies accumulated charge into a voltage, and outputs the voltage as an output signal.

The CPU 15 includes a light emission controller 151, an output amount detector 152, a computational unit 153, a signal amplification amount controller 154, an exposure controller 155, a measuring unit 156, and a shape information generator 157.

The light emission controller 151 controls light emission from the light emitter 12. The output amount detector 152 detects the amount of exposure output for each pixel p for a single light emission from the light emitter 12, based on an output signal output for each pixel p of the image sensor 14.

The computational unit 153 acquires, as a reference exposure output amount, the exposure output amount for each pixel p detected by the output amount detector 152, based on an output signal output by each light receiver r after light reception at exposure timing, when each light receiver r receives all of the reflected light reflected by a measurement object for a single light emission from the light emitter 12. In the present embodiment, the computational unit 153 sets the number of light emissions and exposures for each pixel p for measuring the distance to a measurement object, as a measurement condition. The computational unit 153 calculates (computes) the measurement condition, based on the reference exposure output amount obtained for each pixel p.

The signal amplification amount controller 154 controls the amount of signal amplification by a signal amplifier am of each pixel p of the image sensor 14. The exposure controller 155 controls exposure time and exposure timing at each pixel p of the image sensor 14.

The measuring unit 156 measures the distance to a measurement object for each pixel p, based on an output signal detected by the output amount detector 152, under the measurement condition computed by the computational unit 153. The shape information generator 157 generates 3D shape information of a measurement object using information measured by the measuring unit 156.

### <Operation of 3D Shape Measurement Device>

As a general operation of the 3D shape measurement device 1, processing to generate 3D shape information of a measurement object using dToF (Direct Time of Flight) technology will be described below.

The measurement object is placed in a measurement target range of the 3D shape measurement device 1, and when the light emitter 12 emits laser light toward the measurement object under control of the light emission controller 151, the emitted laser light is reflected by the measurement object. The laser light reflected by the measurement object enters the lens 13 and is received by the light receiver r of each pixel p of the image sensor 14.

In the image sensor 14, light received by each light receiver r is subject to photoelectric conversion, and the signal amplifier am, which corresponds to each light receiver r, converts an electric charge generated by the photoelectric conversion into a voltage, amplifies it, and outputs it as an output signal. The output amount detector 152 detects the exposure output amount for each pixel p of the image sensor 14, based on the output signal output from the signal amplifier am. The output amount detector 152 sends the detected exposure output amount to the measuring unit 156.

The measuring unit 156 measures the distance to the measurement object for each pixel p, based on the exposure output amount detected by the output amount detector 152.

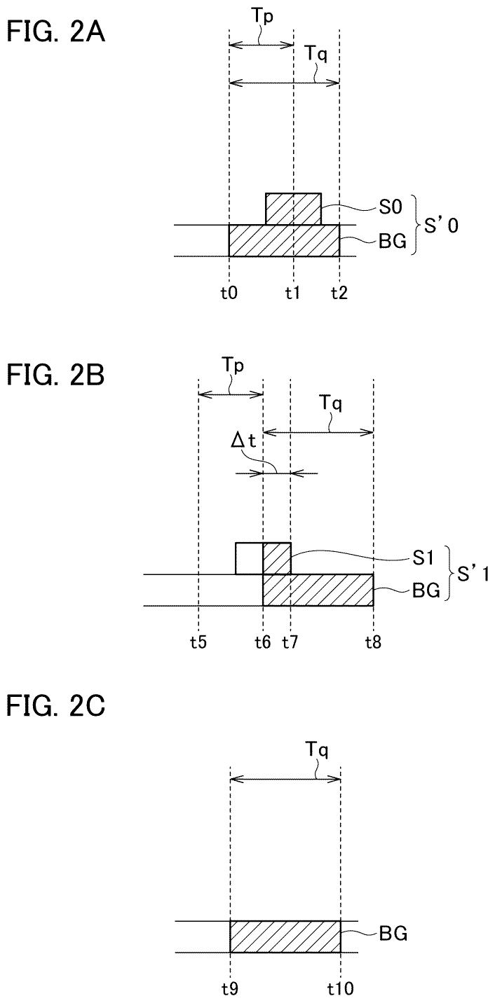

Parameters used by the measuring unit 156 for measuring the distance to the measurement object for each pixel p will be described. FIG. 2A is a diagram illustrating an exposure output amount S′0 output from a pixel p when: laser light is emitted from the light emitter 12 with the measurement object included in a subject; and exposure is performed by setting exposure time and exposure timing to include all of the laser light reflected by the measurement object.

In FIG. 2A, Tp (time t0 to t1) is a light emission time of laser light from the light emitter 12, and Tq (time t0 to t2) is an exposure time at the light receiver r. The exposure output amount S′0 output from the pixel p within the exposure time Tq includes an exposure output amount S0 of reflected light by the measurement object, and an exposure output amount BG of reflected light by the background other than the measurement object. The exposure output amount S0 is used as a reference exposure output amount in a computational process of a measurement condition, and a measurement process of the measurement object, described below.

Here, the start timing of the exposure time Tq is the time to, which is the same as the start timing of the light emission time Tp. The time t2, which is the end timing of the exposure time Tq, is later than the time t1, which is the end timing of the light emission time Tp, and is a time after exposure with all of the reflected light by the measurement object included.

FIG. 2B is a diagram illustrating an exposure output amount S′1 output from the pixel p when: laser light is emitted from the light emitter 12 with the measurement object included in a subject; and exposure is performed at exposure timing where the exposure output amount increases as light reception timing where the laser light reflected by the measurement object is received by the light receiver r is delayed relative to the light emission timing where the light emitter 12 emits the laser light.

In FIG. 2B, Tp (time t5 to t6) is a light emission time of laser light from the light emitter 12, and Tq (time t6 to t8) is an exposure time at the light receiver r. The exposure output amount S′1 output from the pixel p within the exposure time Tq includes an exposure output amount S1 of reflected light by the measurement object, and the exposure output amount BG of reflected light by the background other than the measurement object.

Here, the start timing of the exposure time Tq is the time t6, which is the same as the end timing of the light emission time Tp. The exposure output amount S1 is for reflected light by the measurement object within a period from the time t6, which is the start timing of exposure, to the time t7, which is the end timing of receiving the reflected light by the measurement object. Exposure time Δt is a time from the time t6, which is the start timing of exposure, to the time t7, which is the end timing of receiving the reflected light by the measurement object. The exposure time Δt becomes a larger value as the distance from the pixel p to the measurement object is longer.

The ratio of the exposure time Δt to the light emission time Tp is equal to the ratio of the exposure output amount S1 to the reference exposure output amount S0, as indicated in equation (1) below.

$$Δ t / Tp = S 1 / S 0 \qquad ( 1 )$$

FIG. 2C is a diagram illustrating an exposure output amount output from the pixel p when exposure is performed without light emission in a state where the measurement object is not included in a subject.

In FIG. 2C, Tq (time t9 to t10) is an exposure time in the light receiver r. The exposure output amount output from the pixel p within the exposure time Tq is the exposure output amount BG of reflected light by the background other than the measurement object.

In a single measurement of the measurement object, the measuring unit 156 performs exposure in the three ways illustrated by FIGS. 2A, 2B, and 2C described above, and acquires the exposure output amounts S′0, S′1, and BG of each pixel in the image sensor 14, and values of S0 and S1 calculated from these. Using the acquired values, the measuring unit 156 measures the distance to the measurement object for each pixel p.

Here, since the light emission time Tp is very short (for example, a few nanoseconds), it is difficult to obtain an exposure output amount used for calculating the distance to the measurement object in a single light emission and exposure. Therefore, the measuring unit 156 repeats a light emission and exposure n times, at a time interval longer than the exposure time Tq, and accumulates exposure output amounts to obtain an exposure output amount used for calculating the distance to the measurement object.

That is, the measuring unit 156 calculates the reference exposure output amount S0 in FIG. 2A according to equation (2) below.

$$S 0 = n \times ( S ’ 0 - BG ) \qquad ( 2 )$$

The measuring unit 156 calculates the exposure output amount S1 in FIG. 2B according to equation (3) below.

$$S 1 = n \times ( S ’ 1 - BG ) \qquad ( 3 )$$

In equations (2) and (3), n is an integer. Using the various parameters described above, the measuring unit 156 calculates a distance Z to the measurement object for each pixel p according to equation (4) below.

$$Z = c \times Δ t 2 = c \times Tp / 2 \times ( S 1 / S 0 ) \qquad ( 4 )$$

In equation (4), c is the speed of light.

Meanwhile, when photographing is performed with a general digital camera device, the amount of exposure to an image sensor is determined using six parameters: (i) light source emission intensity, (ii) subject reflectance, (iii) lens T value, (iv) lens aperture, (v) sensor exposure time, and (vi) signal amplification amount by a circuit.

When photographing is performed with a digital camera device, a photographer changes the parameters (iv), (v), and (vi) according to the parameters (i), (ii), and (iii) described above, and in some cases, increases or decreases the parameter (i), and sets an appropriate imaging condition.

In contrast, when a measurement device such as a 3D shape measurement device measures the distance for each pixel of an image sensor to a subject using the dToF (Direct Time of Flight) technology, (vii) light emission time, and the number of light emissions, and (viii) the number of exposures corresponding to the number of light emissions are added as parameters determining the exposure amount for the image sensor.

When using the dToF technology, the light emission time and exposure time are determined by using a distance range from a measurement device to a measurement object, and these parameters are controlled by using the number of light emissions and exposures n. In order to measure the distance from the measurement device to the measurement object with higher accuracy, it is required to set the n value such that the reference exposure output amount S0 described above becomes a target value as large as possible within the capacity of the light receiver r.

However, depending on the shape of the measurement object, the distance from the 3D shape measurement device 1 differs per pixel p, and thus the n value for bringing the reference exposure output amount S0 closer to the prescribed target value differs per pixel p. Thus, the 3D shape measurement device 1 according to the present embodiment computes an appropriate measurement condition for each pixel p such that the reference exposure output amount S0 detected at all pixels p is as close to the prescribed target value as possible, and then performs the measurement process described above for each pixel p according to the computed measurement condition.

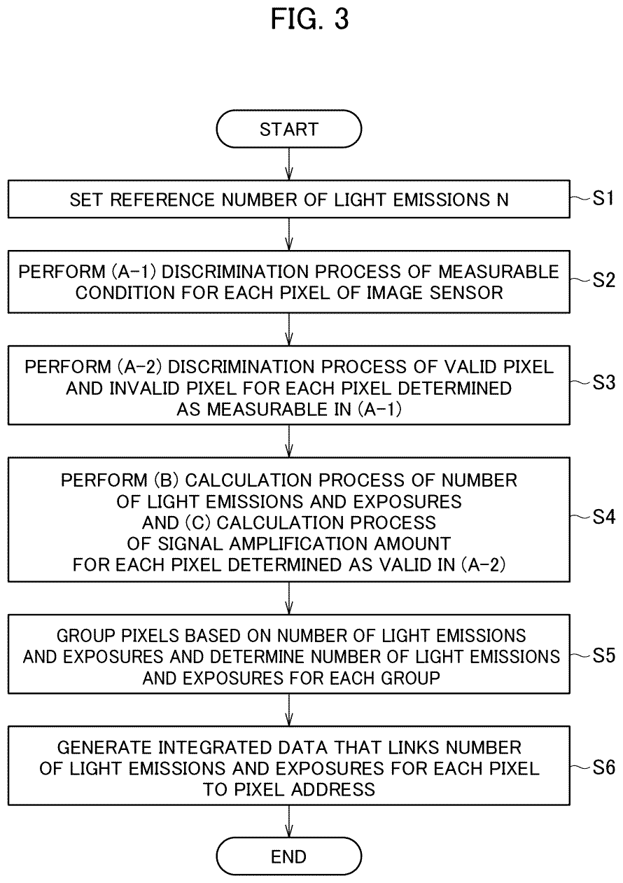

The computational process of measurement conditions, performed by the 3D shape measurement device 1, will be described below. FIG. 3 is a flowchart illustrating processing performed by the CPU 15 when the computational process of measurement conditions is performed.

First, as a reference exposure condition used for calculation of measurement conditions, a user performs an operation (reference number setting operation) to set a reference value of the number of laser light emission, from the light emitter 12, and exposure times in a single measurement process. At this time, the user installs the 3D shape measurement device 1 at a prescribed position in an environment where infrared light from other than the 3D shape measurement device 1 is not easily generated, that is, in an environment where BG is nearly equal to 0. The user installs a subject E which has a high infrared reflectance and does not generate infrared light by itself, at a position further away from a position where the 3D shape measurement device 1 is installed by the minimum measurable distance of the 3D shape measurement device 1. Then, the user performs the reference number setting operation through the input unit 11 of the 3D shape measurement device 1.

When the user performs the reference number setting operation, the 3D shape measurement device 1 measures the reference exposure output amount S0 in a single light emission. Specifically, under control of the light emission controller 151, the light emitter 12 emits laser light, and the light receiver r of each pixel p of the image sensor 14 receives reflected light from the subject E and performs photoelectric conversion. The signal amplifier am converts an electric charge generated by the photoelectric conversion into a voltage, amplifies it, and outputs it as an output signal. The output amount detector 152 detects the reference exposure output amount S0, based on the output signal, and sends it to the computational unit 153.

The computational unit 153 calculates the number of times for accumulation such that the value of the exposure output amount S′0 of the pixel p in center of the image sensor 14 is close to the lower limit (S0 min) of the value of the reference exposure output amount S0 required for proper measurement process, and sets it as the reference number of light emissions n=N (step S1). The value of S0min is predetermined based on the charge capacity of the image sensor 14. That is, the reference number of light emissions N is set such that the reference exposure output amount S0 does not saturate with respect to the charge capacity of the image sensor 14 through the above-described processing.

Next, the user installs the 3D shape measurement device 1 and the measurement object at prescribed positions, and performs a measurement start operation to compute a measurement condition. The computational unit 153 computes the number of light emissions and exposures for each pixel as a measurement condition of the measurement object by the 3D shape measurement device 1. When the measurement start operation for computing a measurement condition is performed, the computational unit 153 performs (A-1) a discrimination process of a measurable condition, (A-2) a discrimination process between a valid pixel and an invalid pixel, (B) a calculation process of the number of light emissions and exposures, and (C) a calculation process of the signal amplification amount, as a computational process of a measurement condition. These processes will be described below.

### (A-1) Discrimination Process of Measurable Conditions

When the measurement start operation for computing measurement conditions is performed, the computational unit 153 first performs a discrimination process of determining whether or not the measurement object can be measured for each pixel p of the image sensor 14 (step S2). In the discrimination process, the number of light emissions and exposures are set to the reference number of light emissions N, and the computational unit 153 measures and accumulates the exposure output amounts S′0 and BG for each emission. The accumulated value of the exposure output amount S′0 of N is set as an exposure output amount S′0(N), and the accumulated value of the exposure output amount BG is set as the exposure output amount BG (N).

Assuming that S′0max is the maximum value that can be obtained by the exposure output amount S′0(N), which is predetermined based on the charge capacity of the image sensor 14, the computational unit 153 determines that a pixel p is measurable which satisfies a measurable condition represented by equation (5) below, that is, a pixel p whose calculated exposure output amount S′0(N) is equal to or less than S′0max.

$$S ’ 0 max \geq BG ( N ) + S 0 min = S ’ 0 ( N ) \qquad ( 5 )$$

Furthermore, the computational unit 153 determines that a pixel p is unmeasurable and does not satisfy the measurable condition represented by equation (5) above, specifically, a pixel p whose calculated exposure output amount S′0(N) is larger than S′0max, because a charge accumulated in the image sensor 14 becomes saturated.

For a pixel p determined to be unmeasurable, the computational unit 153 maintains information indicating that the measurement data of the pixel p is unmeasurable, as a measurement value for the measurement object, corresponding to the corresponding pixel p. The information indicating that the measurement data of the pixel p is unmeasurable is, for example, “0” or a value larger than the maximum value of the assumed number of light emissions and exposures. The unmeasurable pixel p, which does not satisfy equation (5), is, for example, a pixel whose distance to the measurement object is closer than a prescribed measurable range.

### (A-2) Discrimination Process Between Valid Pixel and Invalid Pixel

Next, for each pixel determined to be measurable in (A-1), the computational unit 153 performs a discrimination process of discriminating between a valid pixel satisfying the computed measurement condition (hereinafter, simply referred to as “valid pixel”), and an invalid pixel not satisfying the computed measurement condition (hereinafter, simply referred to as “invalid pixel”) (step S3). In this discrimination process, the number of light emissions and the number of exposures are set to N and a×N, and the computational unit 153 measures and accumulates the exposure output amount S′0 for each light emission, where “a” is an integer, such as “2”. The accumulated value of the exposure output amount S′0 for a× N times is set as the exposure output amount S′0(a×N).

The computational unit 153 determines that a pixel p whose ratio of: the exposure output amount S′0(a×N) when the number of light emissions is a×N; to the exposure output amount S′O(N) when the number of emissions is N, is equal to or greater than a prescribed determination value A. That is, a pixel p satisfying equation (6) below, is a valid pixel. The determination value A is a value appropriately set based on the value of S′0(N), the amount of measurement noise, and the like, and the determination value A increases as “a” increases.

$$S ’ 0 ( a \times N ) / S ’ 0 ( N ) \geq A \qquad ( 6 )$$

In addition, the computational unit 153 determines, as an invalid pixel, a pixel p which does not satisfy equation (6) above, for example, when a=A=2, a pixel p whose exposure output amount S′0 is less than twice even if the number of emissions is doubled.

For the pixel p, which is determined to be an invalid pixel, the computational unit 153 stores: information indicating that data of the exposure output amount S′0 of the pixel p is invalid, such as “0”; or a value larger than the maximum value of the assumed number of light emissions and exposures, as a measurement value for the measurement object, corresponding to the pixel p. The invalid pixel p, which does not satisfy equation (6) above, is, for example, a pixel at a position where the distance to the measurement object is farther than a measurable range, or a pixel at a position where it is difficult to receive reflected light due to the angle of the reflecting surface of the measurement object.

By performing the above-described (A-1) discrimination process of the measurable condition, and (A-2) discrimination process between valid pixel and invalid pixel, the measurement process described below is not performed for an unmeasurable pixel, and a pixel whose exposure output amount S′0 data is determined to be invalid. Thus, the computational unit 153 can reduce unnecessary processing time.

### (B) Calculation Process of the Number of Light Emissions and Exposures, and (C) Calculation Process of Signal Amplification Amount

Next, the computational unit 153 performs a calculation process of the number of light emissions and exposures, and a calculation process of the signal amplification amount, for each pixel determined to be valid in (A-2) (step S4). In this calculation process, the exposure output amount S′0(N) and the exposure output amount BG (N) when the number of light emissions and exposures is N are used.

In order to accurately calculate the distance Z to the measurement object, the S0 value must satisfy equation (7) below. S0max is the maximum value of S0, which is set based on the charge capacity of the image sensor 14, and is capable of properly calculating a measurement condition. S0min is the minimum value of S0, which is assumed to be capable of properly calculating a measurement condition.

$$S 0 max \geq S 0 \geq S 0 min \qquad ( 7 )$$

For each pixel p to be processed, the computational unit 153 calculates the number of light emissions and exposures, and the signal amplification amount so as to satisfy equation (7). Here, if a target value of the reference exposure output amount S0 is S0typ, the computational unit 153 calculates coefficients b and f such that a value calculated by equation (8) below is as close as possible to S0typ. S0typ is predetermined based on, for example, the charge capacity of the image sensor 14.

$$( S ’ 0 ( N ) - BG ( N ) ) \times b \times f \qquad ( 8 )$$

The coefficient b is a value that satisfies equation (9) below.

$$S ’ 0 ( N ) \times b \leq S ’ 0 max \qquad ( 9 )$$

The computational unit 153 calculates a value obtained by multiplying the calculated coefficient b by N as a number of light emissions and exposures N1 of a corresponding pixel p, and calculates the coefficient f as a signal amplification amount. Here, if the value of the coefficient b is set to be as large as possible (maximum value) within a range that satisfies equation (9) above, and if the value of the coefficient f is made as small as possible to approach the target value S0typ of the reference exposure output amount S0, measurement accuracy for the measurement object can be improved. In this case, the signal amplification amount indicated by the coefficient fis set to the same value for all pixels p in the image sensor 14.

If the number of light emissions and exposures N1 is calculated without increasing the value of the coefficient b to the maximum value, and the value of the coefficient f is increased to some extent to approach the target value S0typ of the reference exposure output amount S0, the measurement time for the measurement object can be shortened. In this case, the coefficient f may be set to a different value for each pixel, and the signal amplification amount controller 154 may control the signal amplification amount for each pixel p.

In addition, when calculating the coefficient f, the calculation may include an optical correction amount for correcting the amount of light loss or the like caused by the lens 13. By including the optical correction amount in the coefficient f, the S0 value of all pixels p of the image sensor 14 can be made closer to S0typ, and the distance measurement accuracy among the pixels p can be equalized.

In step S5, the computational unit 153 generates multiple pixel groups G1, G2 . . . by grouping together multiple pixels p having close values calculated based on the number of light emissions and exposures N1 for each pixel p calculated in step S4. At this time, the computational unit 153 generates pixel groups by excluding: a pixel p where information indicating that it is unmeasurable is held in (A-1) discrimination process of measurable condition; and a pixel where information indicating that data of the exposure output amount S′0 is invalid is held in (A-2) discrimination process between valid pixel and invalid pixel.

As the number of pixel groups increases, the time required for a single shape measurement becomes longer. Thus, the number of pixel groups is preferably about four or five at most. In equation (8), the number of pixel groups generated here can be reduced by calculating the coefficient b as an integer and a multiplier of two.

The computational unit 153 determines the number of light emissions and exposures N2_1, N2_2 . . . for pixel group G1, G2 . . . , respectively. Hereinafter, if the pixel group is not specified, the term “pixel group G” is used. If the number of light emissions and exposures is not specified, the term “the number of light emissions and exposures N2” or simply “the number N2” is used.

For example, pixels p whose calculated number of light emissions and exposures N1 is 995 to 1,005 are combined into one pixel group G1, and the number of light emissions and exposures N2 of the pixel group G1 is determined to be 1,000. The number N2_1 for the pixel group G1 is derived, for example, from a histogram indicating the corresponding number of pixels for each calculated number of light emissions and exposures N1 for multiple pixels p belonging to the pixel group G1.

The computational unit 153 sets the numbers N2_1, N2_2 . . . determined for the pixel groups G1, G2 . . . , as the number of light emissions and exposures of each pixel p belonging to the corresponding pixel group G, and generates integrated data that links the number of light emissions and exposures N2 of each pixel p with a pixel address indicating the position of each pixel p (step S6).

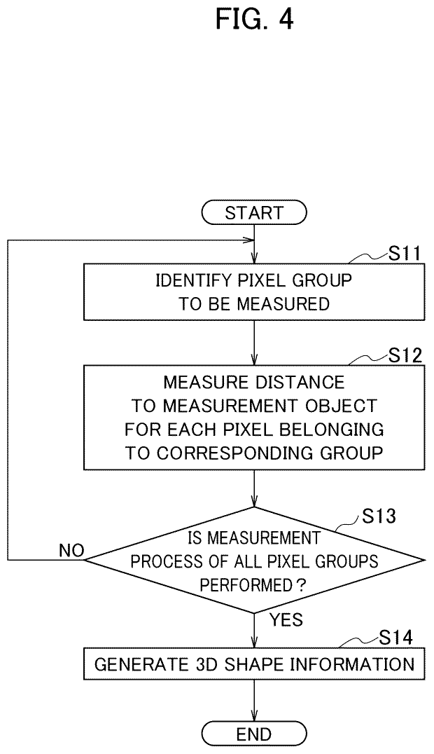

The computational unit 153 sends the generated integrated data to the measuring unit 156. The measuring unit 156 sets the acquired integrated data as a measurement condition of the measurement object, and performs measurement process of the measurement object for each pixel group according to this condition. FIG. 4 is a flowchart illustrating the measurement process performed by the measuring unit 156.

The measuring unit 156 first identifies the pixel group G1 as a pixel group to be measured (step S11), and measures the distance to the measurement object for each pixel p belonging to the corresponding pixel group G1, based on the set measurement condition (step S12).

Specifically, the measuring unit 156 causes: the light emission controller 151 to cause the light emitter 12 to emit light such that the three exposures illustrated in FIGS. 2A, 2B, and 2C are performed for the number N2_1 for the pixel group G1; the image sensor 14 to be exposed under control of the exposure controller 155; and signal amplification to be performed using a signal amplification amount f set by the signal amplification amount controller 154. The output amount detector 152 detects the output signal.

The measuring unit 156 calculates the reference exposure output amount S0 by accumulating the exposure output amounts S′0-BG for the number N2_1 at the exposure timing illustrated in FIG. 2A for each pixel p, based on the exposure output amount detected by the output amount detector 152. The measuring unit 156 calculates the exposure output amount S1 by accumulating the exposure output amount S′1-BG for the number N2_1 at the exposure timing illustrated in FIG. 2B. Then, the measuring unit 156 calculates the distance to the measurement object for each corresponding pixel p using the calculated reference exposure output amounts S0 and S1, and equation (4) above.

Similarly, the process of calculating the distance to the measurement object for each corresponding pixel p is performed for the pixel groups G2 and later, and steps S11 and S12 are repeated until the measurement process of all pixel groups G is completed (“NO” in step S13).

When the measurement process of all pixel groups G is completed (“YES” in step S13), the shape information generator 157 generates 3D shape information of the measurement object using measurement information of all pixels p measured by the measuring unit 156 (step S14).

In this way, by grouping the pixels p in the image sensor 14 according to the required number of light emissions and exposures, and performing the measurement process of each group, it is possible to perform the measurement process with high accuracy in a short time.

In the above embodiment, the three-dimensional shape measurement device can obtain uniform and highly accurate measurement data for multiple pixels in the image sensor.

The above-described embodiment describes the case where the computational unit 153 calculates the number of light emissions and exposures for each pixel, as a process of computing a measurement condition, but is not limited to this case. The computational unit 153 may calculate a light emission intensity for each pixel. In this case, the computational unit 153 calculates a value obtained by multiplying the coefficient b of equation (8) above by the initial value of the light emission intensity, as a light emission intensity of the corresponding pixel p, and groups multiple pixels having close calculated values together to generate multiple pixel groups. Then, the computational unit 153 determines the light emission intensity of each pixel group, sets it as the light emission intensity of each pixel belonging to the corresponding pixel group, and associates it with a pixel address of each pixel p to generate integrated data.

Then, the measuring unit 156 sets the generated integrated data as a measurement condition related to the measurement object, and performs the measurement process of the measurement object for each pixel group, that is, for each light emission intensity, under the condition. By performing processing in this way, the number of light emissions and exposures is made smaller than when the number of light emissions and exposures for each pixel is set as a measurement condition, and the measurement time can be shortened.

In the above-described embodiment, the image sensor 14 may be configured such that the number of exposures can be set for each pixel p. By configuring the image sensor 14 in this way, it is possible to perform exposure with the number of exposures corresponding to each pixel p in one sequence of light emission from the light emitter 12 with the largest number of light emissions in the integrated data, and the measurement time can be shortened.

In the above-described embodiment, the light receiver r of the image sensor 14 may be configured such that the background part corresponding to a BG signal is subtracted from received light information before photoelectric conversion of received light is performed. With this configuration, accuracy can be improved when the measurement process is performed in an outdoor environment with many BG signals.

In the above-described embodiment, an image sensor or pixel for performing the computational process of a measurement condition, and an image sensor or pixel for performing the measurement process may be separated. By configuring image sensors in this way, and also configuring the number of exposures to be configurable for each pixel as described above, it is possible to configure a three-dimensional shape measuring device that has high measurement accuracy and can handle moving images.

Although several embodiments have been described above, it is possible to modify or change the embodiments based on the above-described disclosure. All the constituent elements of the above-described and all the features described in Claims may be individually selected and combined as long as these do not contradict with each other.

What is claimed is:

1. A three-dimensional shape measurement device comprising:
a light emitter configured to emit laser light toward a measurement object;
an imaging element having pixels and configured to: receive reflected light that is the laser light reflected by the measurement object based on a prescribed exposure condition for each pixel; perform photoelectric conversion; and output the photoelectric conversion as an output signal;
an output amount detector configured to detect an amount of exposure output for each pixel for a single light emission from the light emitter based on the output signal;
a computational unit configured to: obtain, as a reference exposure output amount, an exposure output amount for each pixel detected by the output amount detector at an exposure timing where all of the reflected light for the single light emission from the light emitter is received; and compute a measurement condition for each pixel based on the reference exposure output amount obtained for each pixel;
a measuring unit configured to measure a distance to the measurement object for each pixel under the measurement condition based on the exposure output amount for each pixel detected by the output amount detector at an exposure timing where the exposure output amount increases as a light reception timing where the reflected light for the single light emission from the light emitter is received by the imaging element is delayed to a light emission timing where the light emitter emits; and
a shape information generator configured to generate three-dimensional shape information of the measurement object using information on the distance to the measurement object for each pixel.

2. The three-dimensional shape measurement device according to claim 1, wherein the computational unit is configured to calculate as the measurement condition: a number of light emissions and exposures for each pixel based on a number of accumulations to bring the reference exposure output amount for each pixel closer to a prescribed target value of the exposure output amount; or a light emission intensity for each pixel to bring the reference exposure output amount for each pixel closer to the target value of the exposure output amount.

3. The three-dimensional shape measurement device according to claim 1, wherein
the computational unit is configured to: determine, as an unmeasurable pixel, a pixel of the pixels having the reference exposure output amount exceeding a charge capacity of the imaging element when accumulated a prescribed number of times; and determine, as an invalid pixel, a pixel of the pixels having the reference exposure output amount not reaching a prescribed value when accumulated a prescribed number of times; and
the measuring unit is configured not to perform a measurement process of the unmeasurable pixel and the invalid pixel.

4. The three-dimensional shape measurement device according to claim 1, wherein
the computational unit is configured to: generate pixel groups each in which pixels having close values of the computed measurement condition are grouped; and determine a measurement condition for each pixel group based on the measurement condition for each pixel belonging to each pixel group, and
the measuring unit is configured to measure, for each pixel group, the distance to the measurement object for each pixel belonging to each pixel group based on the detected exposure output amount for each pixel under the measurement condition determined for each pixel group.

5. A three-dimensional shape measurement method performed by a three-dimensional shape measurement device comprising:
a light emitter configured to emit laser light toward a measurement object;
an imaging element having pixels and configured to: receive reflected light that is the laser light reflected by the measurement object based on a prescribed exposure condition for each pixel; perform photoelectric conversion; and output the photoelectric conversion as an output signal; and
an output amount detector configured to detect an amount of exposure output for each pixel for a single light emission from the light emitter based on the output signal, the method comprising:
obtaining, as a reference exposure output amount, an exposure output amount for each pixel detected by the output amount detector at an exposure timing where all of the reflected light for the single light emission from the light emitter is received, calculating a number of accumulations to bring the reference exposure output amount for each pixel closer to a prescribed target value of the exposure output amount, and calculating, based on the calculated number of accumulations, a number of light emissions and exposures for each pixel which is the measurement condition for each pixel for measuring a distance to the measurement object;
measuring, under the calculated number of light emissions and exposures, the distance to the measurement object for each pixel under the measurement condition based on the exposure output amount for each pixel detected by the output amount detector at an exposure timing where the exposure output amount increases as a light reception timing where the reflected light for the single light emission from the light emitter is received by the imaging element is delayed to a light emission timing where the light emitter emits; and
generating three-dimensional shape information of the measurement object using information on the measured distance to the measurement object for each pixel.
